(19) United States
(12) Patent Application Publication
(10) Pub. No.: US 2020/0101472 A1
(43) Pub. Date: Apr. 2, 2020

(54) CENTRIFUGE WITH COATED WEIR PLATES

(71) Applicant: SIEBTECHNIK GMBH, Mulheim (DE)

(72) Inventors: Jurg POLLMANNS, Niederkruchten (DE); Thomas Wohner, Oberhausen (DE)

(73) Assignee: SIEBTECHNIK GMBH, Mulheim (DE)

(21) Appl. No.: 16/581,852

(22) Filed: Sep. 25, 2019

(30) Foreign Application Priority Data
Sep. 28, 2018 (EP) 18000773.4

(51) Int. Cl. B04B 1/20

(52) U.S. Cl. CPC B04B 1/20; B04B 2001/2083

(57) ABSTRACT

A decanter centrifuge, for separating a sludge into components, with a rotor and a scroll arranged inside the rotor. The rotor is configured at least partially as a solid bowl rotor with at least a cylindrical section and a conical section. The rotor includes a first end face, concluding the cylindrical section of the rotor, with a first diameter, and a second end face, concluding the conical section, with a second smaller diameter. A flange with one or multiple openings is arranged on the first end face, wherein one or multiple weir plates are fastened to the flange which at least partially cover the openings and are arranged to set a liquid level inside the rotor and form a first radial outlet edge for letting out a liquid at the first end face. The weir plates include an elastically deformable coating on their side facing the flange.

The invention relates to a centrifuge, in particular a decanter centrifuge, for separating a sludge into multiple components, with a rotor and a scroll arranged inside the rotor, wherein the rotor is configured at least partially as a solid bowl rotor with at least a cylindrical section and a conical section, wherein the rotor comprises a first end face, concluding the cylindrical section of the rotor, with a first diameter, and a second end face, concluding the conical section, with a second smaller diameter, wherein a flange with one or multiple openings is arranged on the first end face, wherein one or multiple weir plates are fastened to the flange, which plates at least partially cover the openings and are arranged inside the rotor to set a liquid level and form a first radial outlet edge for letting out a liquid at the first end face.

Such types of centrifuges are known. It has been shown to be disadvantageous that breeding places for bacteria can form in the contact region between the weir plate and the rotor. Such types of centrifuges known from the prior art therefore do not find use in applications in which hygienic cleanliness is required.

The object of the invention is therefore to provide a centrifuge which can be used in hygiene applications.

This object is achieved according to the invention by means of a centrifuge according to claim 1. Advantageous further developments of the invention are specified in the dependent claims.

It is particularly advantageous in the centrifuge, in particular a decanting centrifuge for separating a sludge into multiple components, with a rotor and a scroll arranged inside the rotor, wherein the rotor is configured at least partially as a solid bowl rotor with at least a cylindrical section and a conical section, wherein the rotor comprises a first end face, concluding the cylindrical section of the rotor, with a first diameter, and a second end face concluding the conical section with a second smaller diameter, wherein a flange with one or multiple openings is arranged on the first end face, wherein one or multiple weir plates are fastened on the flange, which plates at least partially cover the openings and are arranged to set a liquid level inside the rotor and form a first radial outlet edge for letting out a liquid on a first end face, that the weir plates at least partially comprise an elastically deformable coating on their side facing the flange.

The weir plates which at least partially comprise an elastically deformable coating on their side facing the flange serve to avoid a gap formation and thus for the sealing between the rotor and the weir plates. In the fastening of the weir plates to the flange, the coating is squeezed between the weir plates and the flange, due to its elastic deformability, so that possible gaps between the weir plates and the flange are closed off. In this way, possible gaps forming between the weir plates and the flange is prevented, which gaps can function as breeding grounds for bacteria, which can contaminate the liquid to be discharged via the first end face. A centrifuge according to the invention is thus employable in hygienic applications, for example in the foodstuffs industry, without here taking the risk of a contamination.

In particular, separation into two components can occur, in particular a solid matter part, with is transported away at the second end face of the rotor, and a liquid part, which is transported away at the first end face of the rotor.

Here, a solid bowl centrifuge, a decanter centrifuge or a screen bowl centrifuge with a pre-thickening can be concerned.

Decanter centrifuges work according to the so-called counterflow principle. The sludge to be separated is placed roughly into the middle of the rotor. The sedimented solid matter is conveyed by the scroll circulating with a differential speed to the rotor in the direction towards the small diameter and thus to the second end face, while the clarified liquid overflows over the flange at the first end face of the rotor.

The liquid level determines the ratio between the clarified part and the dry part of the rotor. The liquid level here defines the level of liquid which results in the treatment of the sludge by means of a rotation of the rotor. The liquid level can also be referred to as sump level, the clarified part as sump and the dry part as dry beach. Here, the dry part starts in the conical section of the rotor, depending on the position of the weir plates, and ends with the second end face of the rotor at the smaller diameter of the rotor. The clarified part is thus the part of the rotor in which a level of liquid is present. The dry part of the rotor thus stars at the first end face of the rotor and ends at the dry part of the rotor. The differential speed between the scroll and the rotor is usually realized by a high-power drive, in particular via V-belts.

The screen bowl centrifuge with pre-thickening generally relates to a precedingly described decanting centrifuge in which, adjacent to the second end face of the rotor, a section of the rotor or a further rotor is connected, which is configured as a screen rotor, so that liquid, in particular with small solid matter particles, can flow out via its screen jacket. Larger solid matter particles are here further transported, by means of the scroll, to the free end face of the screen rotor and transported away to the free edge of the screen rotor. The free end face of the screen rotor here refers to end face of the screen rotor facing away from the conical section of the rotor. In such a centrifuge, a separation of the sludge into three components can thus occur: liquid via the first end face, smaller solid matter with liquid via the screen jacket of the screen rotor, and larger solid matter via the free end face of the screen rotor. In particular, further rotors are thus possible adjacent to the second end face of the rotor.

In the solid bowl centrifuge, the rotor is at least partially configured as a solid bowl rotor.

The elastically deformable coating, which is arranged at least on the side of the weir plates facing to the flange, serves to avoid a gap formation, and thus to the sealing between the rotor and the weir plates. In the fastening of the weir plates to the flange, the coating is squeezed between the weir plates and the flange due to its elastic deformability, so that possible gaps between the weir plates and the flange are closed off. In this way, the forming of possible gaps between the weir plates and the flange are prevented, which gaps can act as breeding grounds for bacteria, which can contaminate the liquid to be discharged via the first end face. A centrifuge according to the invention can thus find use in hygienic applications, for example in the foodstuffs industry, without taking a risk of a contamination here.

A reversible deformability of the coat is meant with the elastic deformability. With the second smaller diameter at the second end face of the rotor, it is meant that the second diameter is smaller in comparison to the first diameter at the first end face of the rotor corresponding to the conical course of the conical section tapering towards the second end face.

In particular, the rotor can be positioned in such a manner that its rotational axis is oriented horizontally or at any angle to the horizontal.

In particular, the flange can here merely comprise one opening. In this case, only one weir plate would be arranged. Preferably, the flange comprises n in particular equally distributed openings over its circumference, wherein n is an integer greater than 1, however.

In particular, the weir plates can respectively comprise a coating which respectively fully sheathes to weir plates.

In particular, the cylindrical section and the conical section of the rotor can be configured as a solid bowl rotor.

In particular, such a type of centrifuge can further comprise a drive unit for rotary and/or oscillating movement of the rotor and the scroll running inside the rotor. In particular, such a type of centrifuge can further comprise at least one housing and/or at least one line for transporting the sludge into the rotor and/or at least one washing line for introducing a washing solution, in particular an acid and/or a base, into the rotor and/or at least respectively one container for collecting the matter separated by the centrifuge.

The weir plates preferably comprise the elastically deformable coating at least in a contact region with the flange. The contact region here describes the surfaces of the weir plates and of the flange which, after the fixing of the weir plates, rest on one another or, put another way, would be in contact. An effective prevention of the gap formation is hereby possible without fully coating the weir plate, in particular the side of the weir plates facing the flange.

Preferably, the coating consists at least partially of a plastic material. A plastic material coating can thus be concerned as the coating. In particular, the coating can be produced from a hybrid material, wherein at least a part of the material consists of a plastic material. Plastic materials essentially distinguish themselves through a certain elastic deformability.

The coating preferably consists of an elastomer, in particular of synthetic rubber, in particular of nitrile rubber and/or of ethylene-propylene-diene rubber. The coating thus preferably consists of elastomer, in particular of synthetic rubber, in particular of acrylonitrile butadiene rubber, also referred to as nitrile rubber, and/or of ethylene-propylene-diene rubber, also referred to as EPDM: ethylene-propylene-diene; M-class. Such elastomers distinguish themselves by a high elastic deformability with simultaneously present tensile strength.

The coating is preferably antibacterial and/or antimicrobial. To that end, the coating can in particular consist partially of silver and/or silver ions. In particular, silver and/or silver ions can be integrated in the material matrix of the coating. An avoidance of bacteria is thereby improved.

The flange is preferably formed integrally with the rotor. This can in particular occur through casting and/or flanging of the rotor and/or welding of the flange to the rotor.

Alternatively, the flange and the rotor can be configured in a multi-part manner, the flange and the rotor can in particular be force-fittingly and/or integrally and/or form-fittingly connected with one another, in particular by means of a screw connection and/or a riveting.

The weir plates are preferably fixable to the flange in multiple different positions, in particular adjustably and fixable to the flange. Depending on a desired liquid level inside the rotor, the weir plates can thus be fixed, in a radial direction of the flange, in different positions. In this way, the position of the first radial outlet edge on the radial course of the flange can be adjusted. The liquid level is thereby flexibly settable and can be optimally adapted, depending upon separation task and/or the features of the sludge to be treated.

The weir plates are preferably adjustable in a continuous or stepwise manner and fixable to the flange. Depending on desired liquid level inside the rotor, the weir plates can thus be adjusted to different positions in the radial direction of the flange and fixed to the flange. In this way, the position of the first radial outlet edge on the radial course of the flange can be adjusted. The parameters of the centrifuge are thereby flexible and can be optimally adapted depending on separation task.

To that end, the flange can in particular comprise multiple threaded bores at different heights with respect to the radial course of the flange, wherein fastening screws can be screwed into the threaded bores, by means of which the weir plates are fixable. Depending on desired liquid level inside the rotor, the weir plates can thus be fixed, in a stepwise manner, in higher positioned or lower positioned threaded bores by means of the fastening screws. A threaded bore displaced along the diameter in a direction towards the circle center of the flange, relative to a lower positioned threaded bore, is referred to with the term “a higher positioned threaded bore”.

Alternatively, the weir plates can also be adjustable in a continuous manner. For example, the weir plates can comprise elongate holes to that end, through which fastening screws engage through and fix the weir plates at the desired height. Alternatively, the weir plates can per se comprise one or multiple openings for continuous adjustment, which openings, depending on positioning of the weir plates, in particular the rotation thereof, form a higher or a lower outlet edge and thus make a higher or lower liquid level inside the rotor possible.

The rotor and/or weir plates preferably consist of a metal, in particular of a metal alloy. A firm fixing with a high bearing capacity can thereby be ensured.

The coating is preferably form-fittingly and/or force-fittingly and/or integrally connected with the weir plate(s). What is meant is that respectively one coating occurs per respective weir plate. A firm connection between coating and weir plate is important, as great forces are exerted thereupon in the operation of the centrifuge. In particular, a press-fit/interference-fit and/or an adhering between the coating and the weir plate can occur.

The coating is preferably produced by means of a plastic material encapsulation of the respective weir plates. A particularly firm connection with the weir plates and a high reproducibility are thereby made possible.

The weir plates preferably respectively comprise at least one negative profile, which interacts with a corresponding positive profile of the coating, in particular in that a press-fit exists between the profiles. In particular, the respective weir plate and the coating can respectively comprise multiple such profiles.

The weir plates preferably respectively comprise at least one positive profile, which interacts with a corresponding negative profile of the coating, in particular in that a press-fit exists between the profiles. In particular, the respective weir plate and the coating can respectively comprise multiple such profiles.

The weir plates are preferably respectively fastened to the flange by means of fastening elements, which engage through at least one through-hole of the weir plate, wherein the coating comprises a perforation in a region surrounding the through-hole so that, in this region surrounding the through-hole, a direct contact exists between the weir plates and the flange. By means of such a perforation of the coating, it is ensured that a load-bearing connection, in particular screw connection, is possible between the weir plates and the flange. The bearing capacity is possible in that simply no coating is present in this region so that, in this region, the weir plate and/or the weir plates abut(s) directly on the flange, so that actually no elastically deformable coating is disposed therebetween.

Alternatively or cumulatively, the coating can comprise such types of perforations on the side of the weir plate facing away from the flange, so that a direct contact exists between the fastening elements and the weir plate in the region surrounding the through-hole.

An exemplary embodiment of the invention is illustrated in the figures. They show:

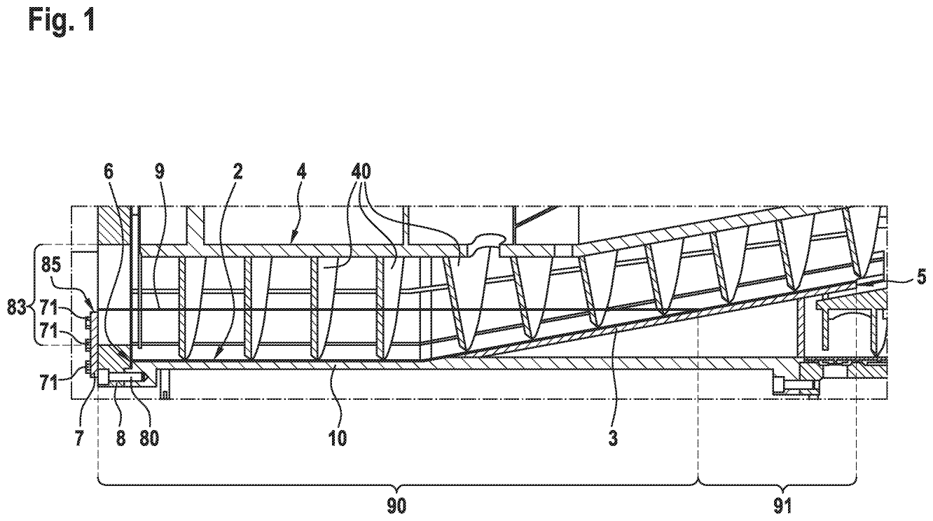

FIG. 1 a partial view of a cross section through a centrifuge according to the invention, with weir plates, in a first radial position;

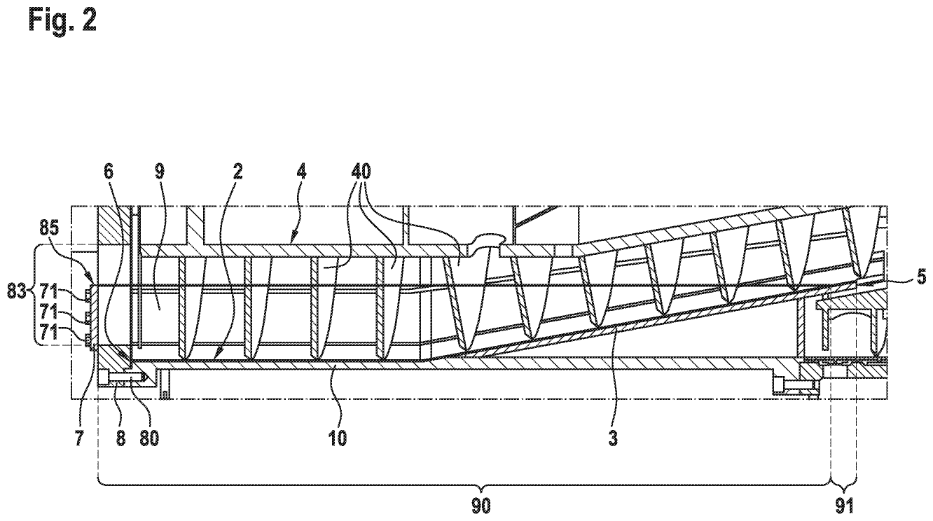

FIG. 2 a partial view of a cross section through a centrifuge according to the invention, with weir plates, in a second radial position;

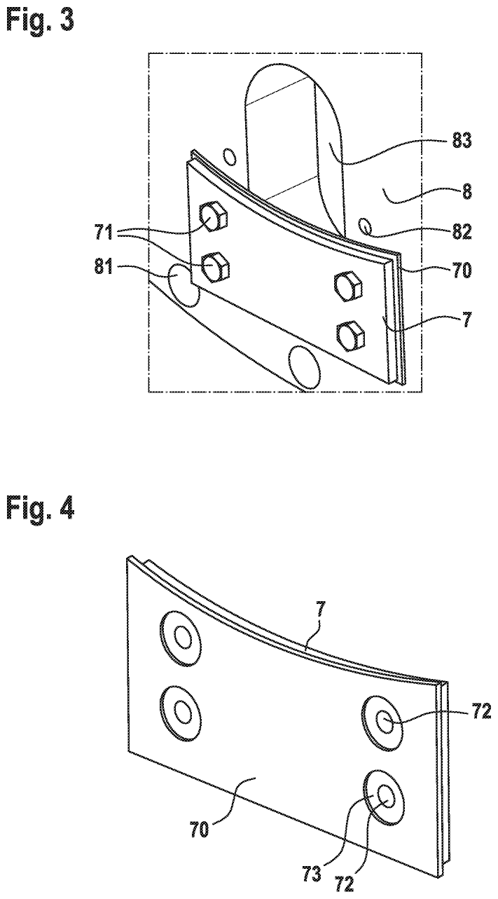

FIG. 3 a perspective view of a weir plate on a flange;

FIG. 4 a perspective view of the weir plate according to FIG. 3.

Identical components and assemblies are referred to in the figures with the same reference characters.

FIG. 1 shows a partial view of a cross section through a centrifuge according to the invention. Here, a rotor with a cylindrical section 2 and a conical section 3 is discernable, wherein the rotor is rotatably mounted in a housing 10. Inside the rotor, a scroll 4 with a plurality of scroll threads 40 is also rotatably mounted. Here, the rotor comprises a first end face 6 which is located left at the drawing plane. Right at the drawing plane, the rotor further comprises a second end face 5, which comprises a smaller diameter relative to the first end face 6. The rotational axis of the rotor not discernable in FIG. 1 is oriented horizontally.

A flange 8 is arranged on the end face 6 of the rotor and is fastened by means of multiple screws 80. The flange 8 comprises multiple openings 83 uniformly distributed over its circumference. Multiple weir plates 7 are further fastened, by means of screws 71, to the flange 8, distributed over its circumference, which plates partially cover the openings 83. Due to the fact that the weir plates 7 partially cover the openings 83 of the flange 8, the weir plates 7 define a first radial outlet edge 85 for letting out a liquid at the first end face 6.

A level of liquid 9 thereby occurs inside the rotor during the treatment of a sludge by means of the centrifuge. The treatment occurs in that the rotor and the scroll 4 are rotated with a differential speed. Further recognizable is a clarified part 90 of the rotor, in which the liquid accumulates, and the solid matter part 91 of the rotor, in which the separated solid matter is located inside rotor and is continuously transported away via the second end face 5 by means of the scroll threads 40. The clarified part 90 can further be referred to as sump, and the solid matter part 91 as dry beach. Accordingly, the liquid is led away out of the rotor via the outlet edge 85 defined at the image plane at the left end face 6 by the correspondingly positioned weir plates 7.

The weir plates 7 are adjustable, with respect to their radial height, with respect to the radial course of the flange 8 and fixable to the flange 8 by means of the screws 71. To that end, the flange 8 comprises multiple threaded bores corresponding to the screws 71, which bores are arranged distributed in its radial course. Via the adjustment of the weir plates 7, the radial position of the outlet edge 85 and thus the liquid level 9 inside the rotor can be set. Further, the weir plates 7, on their side facing to the flanges 8, comprise an elastically deformable coating from an elastomer, which is not discernable in FIG. 1. The coating prevents a gap formation between the flange 8 and the weir plates 7, so that no bacteria can nest therein. Such a centrifuge can thereby also find use in hygienic applications, in particular in the foodstuffs industry.

FIG. 2 shows an arrangement according to FIG. 1, wherein it is discernable that the weir plates 8 were adjusted to a radially higher level, so that the level of liquid 9 is higher than in the illustration according to FIG. 1. In this way, the clarified part 90 is larger relative to the illustration from FIG. 1, whereas the dry part 91 is smaller.

Through the possibility of the radially variable positioning of the weir plates 7 on the flange 8, the centrifuge can be adapted to the operational requirements, as the ratio of clarified part 90 and dry part 91 is hereby likewise variably adaptable.

FIG. 3 shows a perspective view of a weir plate 7 which is arranged on the flange 8. The weir plate 7 here partially covers the opening 83 of the flange 8. The weir plate 7 is here fastened to the flange by means of four screws 71. To that end, the screws 71 are screwed in threaded bores 82 of the flange 8. Further, a coating 70 of the weir plate 7 is discernable, which coating was squeezed between the weir plate 7 and the flange 8 after the fastening of the weir plate 7 by means of the screws 71. In this way, the coating 70 squeezed between the weir plate 7 and the flange 8 prevents gaps from forming between these elements, in which gaps breeding grounds for bacteria can come about.

FIG. 4 shows a perspective view of the weir plate 7 according to FIG. 3, wherein the side of the weir plate 7 facing the flange is illustrated. It is recognizable that the coating 70 comprises perforations 73 around the region of the through-holes 72 of the weir plate 7. These perforations 73 serve to achieve a load-bearing connection between the weir plate 7 and the flange 8 in that the regions around the through-holes 72 are free of a coating 70. In this way, the weir plate 7 and the flange 8 lie directly on top of one another in the regions around the through-holes 72, so that a load-bearing connection between the two components is made possible.

1.-14. (canceled)

15. A centrifuge, in particular a decanter centrifuge, for separating a sludge into multiple components, with a rotor and a scroll arranged inside the rotor, wherein the rotor is configured at least partially as a solid bowl rotor with at least a cylindrical section and a conical section, wherein the rotor comprises a first end face, concluding the cylindrical section of the rotor, with a first diameter, and a second end face, concluding the conical section, with a second smaller diameter, wherein a flange with one or multiple openings is arranged at the first end face, wherein one or multiple weir plates are fastened to the flange, which at least partially cover the openings and are arranged to set a liquid level inside the rotor and form a first radial outlet edge for letting out a liquid at the first end face, wherein the weir plates at least partially comprise an elastically deformable coating on their side facing to the flange.

16. The centrifuge according to claim 15, wherein the weir plates comprise the elastically deformable coating, at least in one contact region with the flange.

17. The centrifuge according to claim 15, wherein the coating at least partially consists of a plastic material.

18. The centrifuge according to claim 15, wherein the coating consists of an elastomer, in particular of synthetic rubber, in particular of nitrile rubber and/or of ethylene-propylene-diene rubber.

19. The centrifuge according to claim 15, wherein the coating is antibacterial and/or antimicrobial.

20. The centrifuge according to claim 15, wherein the flange is formed integrally with the rotor.

21. The centrifuge according to claim 15, wherein the weir plates are fixable to the flange in multiple different positions.

22. The centrifuge according to claim 15, wherein the weir plates are adjustable in a continuous or stepwise manner and are fixable to the flange.

23. The centrifuge according to claim 15, wherein the rotor and/or weir plates consist of a metal, in particular of a metal alloy.

24. The centrifuge according to claim 15, wherein the coating is form-fittingly and/or force-fittingly and/or integrally connected with the weir plates.

25. The centrifuge according to claim 15, wherein the coating is produced by means of a plastic material encapsulation of the respective weir plates.

26. The centrifuge according to claim 15, wherein the weir plates respectively comprise at least one negative profile, which interacts with a corresponding positive profile of the coating, in particular in that a press-fit exists between the profiles.

27. The centrifuge according to claim 15, wherein the weir plates respectively comprise at least one positive profile, which interacts with a corresponding negative profile of the coating, in particular in that a press-fit exists between the profiles.

28. The centrifuge according to claim 15, wherein the weir plates are respectively fastened to the flange by means of fastening elements, which engage through at least one through-hole of the weir plate, wherein the coating comprises a perforation in a region surrounding the through-hole, so that a direct contact between the weir plates and the flange exists in this region surrounding the through-hole.
